(19) United States
(12) Patent Application Publication
(10) Pub. No.: US 2010/0266984 A1
(43) Pub. Date: Oct. 21, 2010

(54) BUR FOR MAXILLARY SINUS AUGMENTATION

(76) Inventor: Sung Min JUNG, Seoul (KR)

Correspondence Address: Workman Nydegger;1000 Eagle Gate Tower, 60 East South Temple, Salt Lake City, UT, 84111, US

(21) Appl. No.: 12/478,915

(22) Filed: Jun. 5, 2009

(30) Foreign Application Priority Data
Apr. 17, 2009 (KR) 10-2009-0033800

(51) Int. Cl. A61C 3/06

(52) U.S. Cl. 433/166

(57) ABSTRACT

A bur for maxillary sinus augmentation is disclosed. The bur uses a drill for rapid and easy perforation and expansion of maxilla as a preliminary surgery such that easy and convenient placement of dental implants is carried out without injuring subantral membrane. The bur includes a head, a body, a tool mount, and a perforation bur for a crestal approach technique including a head having a round top coated with irregular coarse diamond particles.

### CROSS-REFERENCE TO RELATED APPLICATION

This application claims priority to and the benefit of Korean Patent Application No. 10-2009-0033800, filed on Apr. 17, 2009, the entire content of which is incorporated herein by reference.

### BACKGROUND OF THE INVENTION

1. Field of the Invention

The present invention relates to a bur for maxillary sinus augmentation, and more particularly, to a bur for enabling easy maxillary sinus augmentation by easy and convenient boring of maxilla without injuring of subantral membrane.

2. Description of the Related Art

Two maxillary sinuses are respectively placed on upper sides of roots of molars in the form of cavities surrounded by bone.

When a molar on maxilla is extracted, insufficient bone mass of maxilla gives a difficulty for the placement of dental implants.

In this case, the placement of dental implants is enabled by an operation using artificial bones that are placed on an empty space above alveolar bone to compensate insufficient bone of maxilla.

In other words, where a bone graft is transplanted on maxilla, a bone graft powder is transformed into a hard bone such that the maxilla has a sufficient thickness for the placement of dental implants.

The methods of maxillary sinus augmentation for the placement of dental implants by elevating maxillary sinus formed as described above are classified into a crestal approach technique and lateral window technique.

The crestal approach technique is a method that when a residual ridge is somewhat remained in a region for the placement of dental implants (more than thickness 4 mm of the residual ridge) a hole of 2 to 3 mm diameter is formed in maxilla by hammering maxilla several times with solid cylindrical osteotomes and then a bone graft is introduced through the hole.

This crestal approach technique reduces edema in a patient due to a narrow region for a surgical operation. However, there are some problems in this technique. Since a subantral membrane cannot be seen with a naked eye during the operation, the operation is very cautiously performed for a long time while inspecting subantral membrane by X-ray and impacts during the operation causes patient's unpleasant feelings.

The lateral window technique is a method that when a residual ridge is too insufficient (less than the thickness 4 mm of the residual ridge) a hole is formed on a lateral side of maxilla and then bone graft is introduced through the hole after subantral membrane is elevated.

This technique provides less chance to result in injuring subantral membrane because of the subantral membrane can be seen with a naked eye and be elevated during the operation. Even when the subantral membrane is injured post-treatment is possible in this operation. Further, rapid operation is possible because a desired amount of bone graft can be introduced in one time. However, severe edema may happen due to a wide operation region and the operation has a difficulty to form a dissection region having a certain area in maxilla.

In addition to the above-mentioned technique, there is a maxillary sinus augmentation technique utilizing a drill. Since the technique utilizing a drill has no device preventing a sharp blade edge of a bur from contacting subantral membrane when boring of maxilla by rotation of the drill is finished, it is inevitable that subantral membrane is torn to pieces or is wounded around the drill. Therefore, it is difficult to perform a maxillary sinus augmentation technique utilizing a drill today.

### BRIEF SUMMARY OF THE INVENTION

The present invention provides a bur for maxillary sinus augmentation enabling rapid and easy perforation and expansion of the maxilla with a drill as a preliminary surgery for easy and convenient placement of dental implants without injuring subantral membrane.

In accordance with the aspects of the present invention, there is provided a bur for maxillary sinus augmentation comprising: a head; a body; a tool mount; and a perforation bur for a crestal approach technique including a head having a round top coated with irregular coarse diamond particles.

There is also provided a bur for maxillary sinus augmentation comprising: a head; a body; a tool mount; and a perforation bur for a lateral window technique including a head part having a round top coated with irregular and coarse diamond particles.

The bur for maxillary sinus augmentation further comprises an expansion bur including a body for expanding a hole after the hole is perforated in maxilla by the perforation bur.

According to the bur of the present invention,

1. the round head of the bur of the drill prevents subantral membrane from being injured;

2. cutting force is improved by coating the head of the bur with diamond particles; and

3. the perforation bur used in the crestal approach technique includes a stopper provided in a body such that subantral membrane can be prevented from being injured due to excessive perforation into maxilla.

### BRIEF DESCRIPTION OF THE DRAWINGS

The exemplary embodiments of the present invention will be more apparent from the following detailed description in conjunction with the accompanying drawings, in which:

FIGS. 1 and 2 are side views illustrating perforation burs of a bur for maxillary sinus augmentation used in a crestal approach technique;

FIG. 3 is a sectional view illustrating a perforation bur of a bur for maxillary sinus augmentation according to an embodiment of the present invention, used in a crestal approach technique;

FIGS. 4 and 5 are side views illustrating a perforation bur of a bur for maxillary sinus augmentation according to an embodiment of the present invention, used in a lateral window technique;

FIG. 6 is a side view illustrating an expansion bur of a bur for maxillary sinus augmentation according to an embodiment of the present invention, used in a crestal approach technique and lateral window technique;

FIG. 7 is a sectional view illustrating an expansion bur of a bur for maxillary sinus augmentation according to an embodiment of the present invention, used in a crestal approach technique and lateral window technique; and

FIG. 8 is a view illustrating a stopper mounted around the bur for maxillary sinus augmentation according to the embodiment of the present invention.

### DETAILED DESCRIPTION OF THE INVENTION

Hereinafter, exemplary embodiments of the present invention will be described in detail with the accompanying drawings.

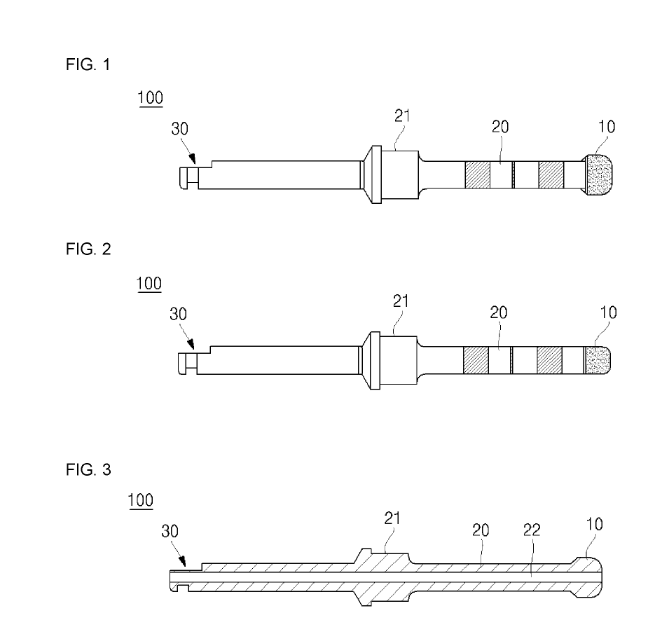

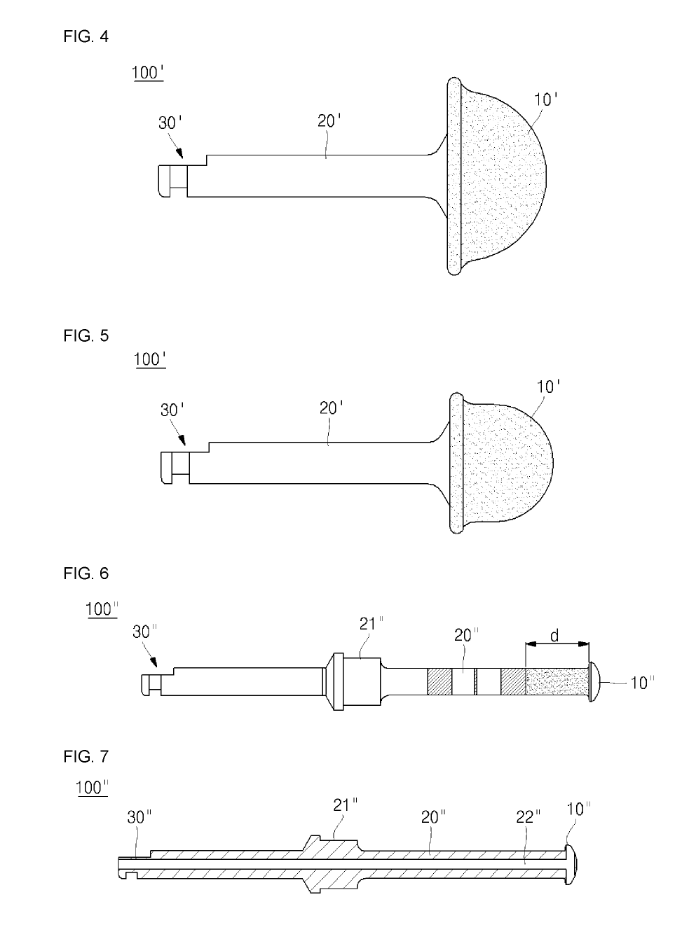

FIGS. 1 to 3 are side and cross-sectional views, respectively illustrating a perforation bur of a bur for maxillary sinus augmentation according to an embodiment of the present invention to be used for a crestal approach technique. FIGS. 4 and 5 are side views respectively illustrating a perforation bur of a bur for maxillary sinus augmentation according to an embodiment of the present invention to be used for a lateral window technique. FIGS. 6 and 7 are side and cross-sectional views respectively illustrating an expansion bur of a bur for maxillary sinus augmentation according to an embodiment of the present invention to be used in both of a crestal approach technique and lateral window technique.

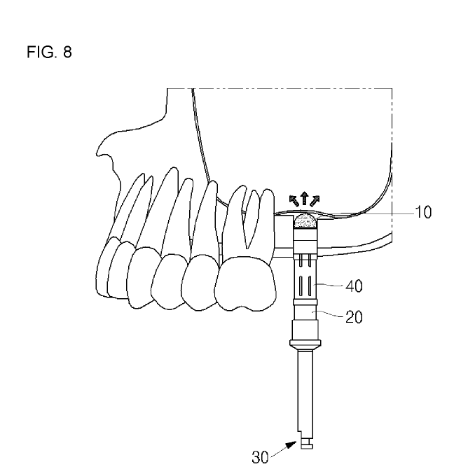

FIG. 8 is a view illustrating a stopper mounted around the bur according to another embodiment of the present invention.

As shown in the accompanying drawings, a bur is mounted to a drill for use and includes a head 10, 10′, and 10″, a body 20, 20′, and 20″, and a tool mount 30, 30′, and 30″.

FIGS. 1 and 2 show a perforation bur 100 for maxillary sinus augmentation to be used in a crestal approach technique when residual ridge is somewhat remained in an operation region. The bur 100 is entirely colored with golden paint to satisfy aesthetic tastes of a patient.

Unlike existing bur having sharp blades, the head 10 of the perforation bur 100 used in the crestal approach technique has a round top as shown in the drawings so that subantral membrane formed inside the maxilla is prevented from being injured during the perforation of the maxilla with the bur 100.

The head 10 serves to perforate a vertical hole in maxilla and to approach to subantral membrane and has a diameter less than that of the head 10′ of a perforation bur 100′ for lateral window technique to be described later in order to reduce a surgical site.

The overall heads 10 and 10′ of the burs 100 and 100′ are coated with irregular coarse diamond particles to have excellent cutting force.

Especially, the heads 10 and 10′ are coated with tin on the diamond particle coating. Tin is an excellent biocompatible material which can effectively cope with soft tissue responses.

After perforation of maxilla using the perforation bur 100 for the crestal approach technique, the perforated maxilla is expanded along with elevating subantral membrane using the expansion bur 100″ as illustrated in FIG. 6. The diameter of the head 10″ of the expansion bur 100″ is not greater than that of the head 10 of the bur 100 and the head 10″ thereof has a smooth round top so that subantral membrane can be safely elevated without injury.

Moreover, a preset length d between a side of the body 20″ and the head 10″ is coated with diamonds such that the bur 100″ can exhibit an excellent cutting force.

After maxilla is perforated to produce a hole by the perforation burs 100 and 100′, the head 10″ of the expansion bur 100″ is inserted into the hole to elevate subantral membrane and the body 20″ is shaken to expand the hole as necessary.

Since the expansion bur 100″ for lateral window technique has the same shape and functions as those of the perforation bur 100 for a crestal approach technique, description of the expansion bur 100″ for a lateral window technique will be omitted, and only perforation bur 100′ for lateral window technique will be described.

The perforation bur 100′ for lateral window technique, as illustrated in FIGS. 4 and 5, includes a head 10′, a body 20′, and a tool mount 30′. The diameter of the head 10′ is relatively larger than that of the head 10 of the perforation bur 100 for a crestal approach technique.

This larger head part 10′ allows an operator to easily see the inside of maxilla because the operator should inspect subantral membrane with naked eyes while a lateral window technique is carried out. Furthermore, the larger the diameter of the head 10′ rotated by the drill is, the easier and the faster a large hole is perforated in maxilla.

The head 10′ of the bur 100′ is coated with irregular coarse diamond particles to exhibit excellent cutting force like a case of the head 10 of the perforation bur 100 for a crestal approach technique. Especially, the head 10 is coated with tin on the diamond particles to effectively cope with soft tissue responses.

Therefore, after maxilla is perforated by the perforation bur 100′, the head 10″ of the expansion bur 100″ is inserted into the hole to elevate subantral membrane and the body 20″ is shaken to expand the hole as necessary.

Subantral membrane is not usually injured during the operation with the lateral window technique. However, since subantral membrane may be directly injured during the operation with the crestal approach technique, in order to prevent subantral membrane from being injured, the perforation bur 100 includes a cylindrical stopper 40 with a preset width as a safety device fixed to a circumferential surface of the body 20 of the bur 100.

A blocking step 21 to block backward movement of the stopper 40 is integrated with a preset region on the circumferential surface of the body 20 such that the perforation bur 100 cannot be inserted into a depth where subantral membrane may be injured.

In other words, when the perforation bar 100 perforates into maxilla and is moved to the depth where subantral membrane is injured and when a leading edge of the stopper 40 having a preset width protrudes outwardly and touches the surface of maxilla, the stopper 40 blocks the bur 100 from being inserted into maxillary sinus further.

In this case, since every patient has a different thickness of maxilla, a distance from the alveolar crest to the sinus floor, a plurality of the stoppers 40 having various widths are prepared. After the thickness of maxilla is measured by X-ray, a stopper 40 having a proper width for the measured maxilla of a patient to be operated on is mounted to the bur 100 for the operation.

The perforation bur 100 and the expansion bur 100″ for a crestal approach technique respectively have irrigation through-holes 22 and 22″ which are formed at the central region from the tool mounts 30 and 30″ to the heads 10 and 10″ in the longitudinal direction so that friction force and heat generated from between subantral membrane and the burs 100 and 100″ are reduced to prevent damage of the subantral membrane.

As shown in FIG. 3, the through-hole 22 of the perforation bur 100 is formed in the region from the tool mount 30 to the head 10, in the longitudinal of the perforation bur 100, so that saline water is discharged through the through-hole 22 and directly vertically reaches the subantral membrane.

Furthermore, as shown in FIG. 7, the through-hole 22″ of the perforation bur 100″ is formed in the region from the tool mount 30″ to the head 10″ in the longitudinal of the perforation bur 100″ and is separated in the head 10″ and extended in the radial direction, so that the saline water is discharged out through the through-hole 22″ and expands subantral membrane elevated by the perforation bur 100.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined by the appended claims.

What is claimed is:

1. A bur for maxillary sinus augmentation comprising:
a head;
a body;
a tool mount; and
a perforation bur for a crestal approach technique including a head having a round top coated with irregular coarse diamond particles.

2. The bur of the claim 1, further comprising an expansion bur including a body for expanding a hole after the hole is perforated in maxilla by the perforation bur.

3. The bur of the claim 1, wherein the perforation bur comprises an irrigation through-hole at a central region thereof from the tool mount to the head in the lengthwise direction.

4. The bur of the claim 2, wherein the expansion bur includes a head having a smooth round top to safely elevate subantral membrane without injury.

5. The bur of the claim 2, wherein the expansion bur includes a head and a preset region coated with diamond particles between a side of the body and the head.

6. The bur of the claim 2, wherein the expansion bur further includes:
a tool mount;
a head; and
an irrigation through-hole formed in a region from the tool mount to the head and separated in the head and extended in the radial direction.

7. The bur of the claim 2, wherein each of the perforation bur and the expansion bur is colored with golden paint.

8. The bur of the claim 2, wherein each of the perforation bur and the expansion bur is coated with tin after being coated with diamond particles.

9. The bur of the claim 2, wherein each of the perforation bur and the expansion bur further comprises;
a cylindrical stopper provided on a circumference of the body and having a preset length to block the bur for maxillary sinus augmentation without injuring of subantral membrane; and
a blocking step integrally formed on the circumference of the body to block backward movement of the stopper.

10. A bur for maxillary sinus augmentation comprising:
a head;
a body;
a tool mount; and
a perforation bur for a lateral window technique including a head part having a round top coated with irregular and coarse diamond particles.

11. The bur of the claim 10, further comprising an expansion bur including a body for expanding a hole after the hole is perforated in maxilla by the perforation bur.

12. The bur of the claim 11, wherein the expansion bur includes a head having a smooth round top to safely elevate subantral membrane without injury.

13. The bur of the claim 11, wherein the expansion bur includes a head and a preset region coated with diamond particles between a side of the body and the head.

14. The bur of the claim 11, wherein each of the perforation bur and the expansion bur is colored with golden paint.

15. The bur of the claim 11, wherein each of the perforation bur and the expansion bur is coated with tin after being coated with diamond particles.

16. The bur of the claim 1, wherein the head of the perforation bur for a crestal approach technique has a diameter relatively less than that of the head of the perforation bur for a lateral window technique.
